(19) United States
(12) Patent Application Publication
(10) Pub. No.: US 2003/0120362 A1
(43) Pub. Date: Jun. 26, 2003

(54) Method for modeling and design of coupled cavity laser devices

(76) Inventor: Andrel Vyacheslavovich Shchegrov, Campbell, CA (US)

Correspondence Address: KENYON & KENYON, Suite 600, 333 West San Carlos Street, San Jose, CA, 95110, US

(21) Appl. No.: 10/028,406

(22) Filed: Dec. 21, 2001

(51) Int. Cl. G06F 7/60; G06F 17/10; G05B 13/02

(52) U.S. Cl. 700/37; 700/30; 700/31

(57) ABSTRACT

A method for modeling and design of a coupled cavity laser device is provided. A coupled cavity laser device includes a resonant cavity that includes at least two sub-cavities. The method of the invention includes selecting device characteristics of the laser, performing round trip iteration calculations, including an inter-cavity field exchange, for each sub-cavity, testing to determine whether a convergence has been reached, and computing a device output beam characteristic.

### FIELD OF THE INVENTION

This invention relates generally to modeling and design of laser devices and, more particularly, to methods for modeling coupled cavity laser systems.

### BACKGROUND INFORMATION

Light Amplification by Stimulated Emission of Radiation (LASER) devices have been known for some time and have become widely used in applications from medical devices to telecommunications to industrial applications. A laser device includes a laser resonance cavity in which light oscillates to generate stimulated emission. The resonance cavity typically comprises at least two mirrors and a gain medium. One of the mirrors is typically a highly-reflective mirror for reflecting light back into the resonance cavity, while the other mirror is partially-reflective so that a first portion of the light contacting it is reflected back into the resonance cavity and a second portion of the light contacting it is allowed to pass through as the output beam of the laser device. Laser gain media can be comprised of a gas such as carbon dioxide or He—Ne, a solid-state material such as ruby or Nd:YAG, or semiconductor materials such as quantum well structures comprised of InGaAs, InP, AlGaAs, and GaAs.

Different laser applications require different characteristics of laser output beams. For example, industrial applications often require extremely high-power output beams, while medical lasers require very narrow beams that can be precisely manipulated. Telecommunications and other fiber-optic laser applications require lasers with output powers within certain ranges (e.g., on the order of tens to hundreds of milli Watts) and manageable and predictable beam shapes and output wavelengths. Semiconductor lasers such as GaAs and InP based lasers have traditionally been used in the telecommunications industry.

Properties of lasers are governed by the resonance of electromagnetic fields oscillating in the laser cavity or cavities. The way light resonates in a laser governs the wavelength of the output light (typically associated with “longitudinal modes” of a laser) and also the shape of the output beam (“transverse mode” of a laser). A circular cross-sectional shape with a Gaussian curve intensity profile is the most basic (and usually desirable) transverse mode, and is referred to as a “fundamental mode” beam shape. The fundamental mode is frequently referred to with the designation “TEM₀₀.” Higher-order modes (e.g., TEM₀₁, TEM₁₁, etc.) have intensity profiles with shapes such as donut, double ring, double and quadruple lobes, and other shapes. An advantage of the fundamental mode shape beam is that this type of beam has the lowest divergence of any of the modes. Low divergence is important for coupling as much power as possible into an optical fiber.

Lasers are capable of operating in a single- or multiple-mode regime. Increasing the laser output power is frequently accompanied by generating higher and higher order transverse modes. A key point in laser design for telecommunications is to get as high an intensity as possible from a laser while keeping the output beam in the fundamental (lowest) mode.

In order to design lasers with desirable characteristics, it is helpful to be able to mathematically model the performance of various laser designs. This modeling may be implemented, for example, through mathematical and software implementations that model various physical phenomena. By modeling a design before building it, engineers can gain insight into device performance and adjust designs without having to spend time and resources building and measuring actual devices unnecessarily. A sufficiently sophisticated model should be able to predict and optimize laser output power, beam quality, mirror reflectivities, spatial properties of the gain medium, sizes and location of beam-shaping elements such as mirrors, lenses, etc. Another important use for such a model is to perform tolerance analysis.

Gardner Fox and Tingye Li developed an iterative modeling algorithm to assist in modeling characteristics of single cavity lasers. See A. G. Fox and T. Li, “Resonant modes in a maser interferometer,” Bell Sys. Tech. J., v.40, pp.453-458 (1961); A. G. Fox and T. Li “Modes in a maser interferometer with curved and tilted mirrors,” Proc. IEEE, v.51, pp.81-89 (1963). This algorithm models the repeated round trips of an optical field in the laser cavity and predicts the evolution of this circulating field into an eigenmode or eigenmodes which have highest gain (lowest loss). The Fox-Li algorithm provides a tool to design cavity parameters to find such eigenmodes and adjust laser design to achieve desired performance (power, spatial beam quality, alignment tolerance, etc.). The Fox-Li algorithm can be applied to model various laser devices through use of standard beam propagation algorithms, which can be coded in a programming language such as C or Fortran, or obtained commercially through optical software programs such as the General Laser Analysis and Design (“GLAD”) software program available from Applied Optics Research, Woodland, Wash.

The essence of the Fox-Li algorithm can be summarized as follows (a more detailed description can be found in the original work of Fox and Li, and A. E. Siegman, “Lasers,” University Science Books, 1986, p.524 (“Siegman”)). An arbitrary electric field E(x, y) at some reference surface (typically, a plane specified by the longitudinal coordinate z) in the laser cavity can be represented as a linear combination of the cavity eigenmodes

$$E ( x , y ) = {\sum }_{n}^{} {A}_{n} {E}_{n} ( x , y ) \qquad Eq . ( 1 )$$

where Eₙ(x, y) are the cavity eigenmodes and Aₙ are the expansion coefficients. The coordinates x and y are called the transverse coordinates, defining a plane perpendicular to the cavity axis coinciding with the coordinate z axis. The cavity eigenmodes are defined by the eigenvalue problem

ĈEₙ(x,y)=ΛₙEₙ(x,y), Eq. (2)

where Λ is an eigenvalue, and Ĉ is the round-trip (circulation) operator that transforms the field on a certain surface in the cavity into the field on the same surface, but after one round trip. A convenient integral representation of the diffractive propagation of light which describes a round trip in a laser cavity is given in Siegman at p. 778.

ĈE(x,y)=∫∫K(x,y,x′,y′)E(x′,y′)dx′dy′ Eq. (3)

where the function K(x, y, x′, y′) is defined by the cavity geometry. It is known from literature (Siegman) how to define K(x, y, x′, y′) for an arbitrarily complex optical system. In the Fox-Li algorithm for a single-cavity resonator, one starts with an arbitrary field distribution E(x, y) containing many eigenmodes (a plane wave or random noise are typically good starting distributions) and repeatedly applies the circulation operator Ĉ. According to Eqs. (1) and (2), the field after m round trips can be represented as

$${\hat{C}}^{m} E ( x , y ) = {\sum }_{n}^{} {{A}_{n} ( {Λ}_{n} )}^{m} {E}_{n} ( x , y ) \qquad Eq . ( 4 )$$

Equation (4) establishes that after many round-trip passes of light in the laser cavity the mode with the largest eigenvalue Λ (i.e. the highest-gain or the lowest-loss) mode will be the dominant mode in the cavity. The loss mechanism differentiating spatial modes is typically introduced by an aperture or apertures. The next-lowest-loss mode can be found by subtracting the obtained fundamental mode component from the spatial field distribution at the beginning of each round-trip pass. The Fox-Li algorithm is commonly represented as a beam propagating through a periodic, infinitely long optical system, where each period corresponds to a round-trip propagation of the beam in a laser cavity.

Subsequent to the development of single cavity lasers, coupled cavity lasers were developed. A coupled cavity laser is one in which the resonance cavity for the laser includes at least two sub-cavities, generally coupled through a partially-reflective mirror. For background and examples of coupled cavity lasers, see, for example U.S. Pat. Nos. 4,550,410; 4,674,096; 4,839,308; 5,936,980. As shown in these examples, multiple laser cavities can be used in a laser device to enhance mode (both longitudinal and transmission) control and stabilization. It has also been argued that multiple-mirror, coupled-cavity lasers may allow achievement of other advantageous characteristics such as bandwidth narrowing and single-frequency laser operation. See Siegman, p.524.

While the Fox-Li methods for modeling laser device performance are useful for single-cavity lasers, they do not directly apply to coupled-cavity designs. When the laser system has more than one cavity, the Fox-Li modeling approach does not prescribe how to build a periodic system for propagating the beam to convergence to the lowest-loss spatial eigenmode. Coupled-cavity designs may be modeled by using an “effective mirror” calculation, as discussed in Siegman at p.526. Once an effective mirror has been calculated to represent the additional mirrors used in a coupled cavity design, the coupled-cavity system may be analyzed with single-cavity models. It is customary to use this approximation for analyzing longitudinal modes of coupled-cavity lasers (Siegman at p.528). One also may apply the Fox-Li method to this representation to analyze and design spatial modes of a coupled-cavity laser. This modeling approximation, while effective for rudimentary applications, has severe limits that prevent it from effectively modeling coupled cavity laser designs. For example, this method does not allow for the accuracy required for many applications. Furthermore, when one of the laser sub-cavities contains an optical element such as, for example, a lens, aperture, optical crystal, etc., the method breaks down since the effective mirror approximation cannot adequately model all phenomena occurring in a complex sub-cavity. A modeling method, therefore, is required for more accurately modeling a coupled cavity laser design.

### SUMMARY OF THE INVENTION

A method for modeling performance characteristics of a laser device is provided. A resonant cavity of the laser device includes at least two sub-cavities. The method includes selecting reference surfaces (typically reference planes) in each sub-cavity, selecting a gain model (e.g., one that employs a gain magnitude characteristic) of at least one sub-cavity of the laser device; selecting a spatial distribution gain characteristic of each sub-cavity; injecting a small field in at least one sub-cavity; performing an intra-cavity round trip iteration calculation for each sub-cavity, including an inter-cavity field exchange; and comparing the magnitudes and spatial distributions of the fields at the selected surfaces in each sub-cavity at the current iteration and the preceding iteration to determine whether convergence has been reached. If convergence has not been reached, an intra-cavity round trip iteration calculation for each sub-cavity is once again performed. If convergence has been reached, output beam characteristics are computed.

### BRIEF DESCRIPTION OF THE DRAWINGS

FIG. 1 shows a block diagram of a coupled cavity laser device of a type that may be modeled using the method of the present invention.

FIG. 2 shows a flow chart of a method for modeling a coupled cavity laser device according to an embodiment the present invention.

FIG. 3 shows a flow of a method for designing a laser device according to an embodiment of the present invention.

### DETAILED DESCRIPTION

The method of this invention allows prediction of circulating and outcoupled optical fields for given electrical and/or optical pump conditions. This allows the optimization of the design of a coupled cavity laser device for maximum-power operation with desired spatial and spectral mode characteristics. The invention is applicable to semiconductor diode lasers, including vertical cavity surface emitting lasers, but is not limited to these devices and can be applied to any coupled cavity laser devices including solid state and gas laser devices.

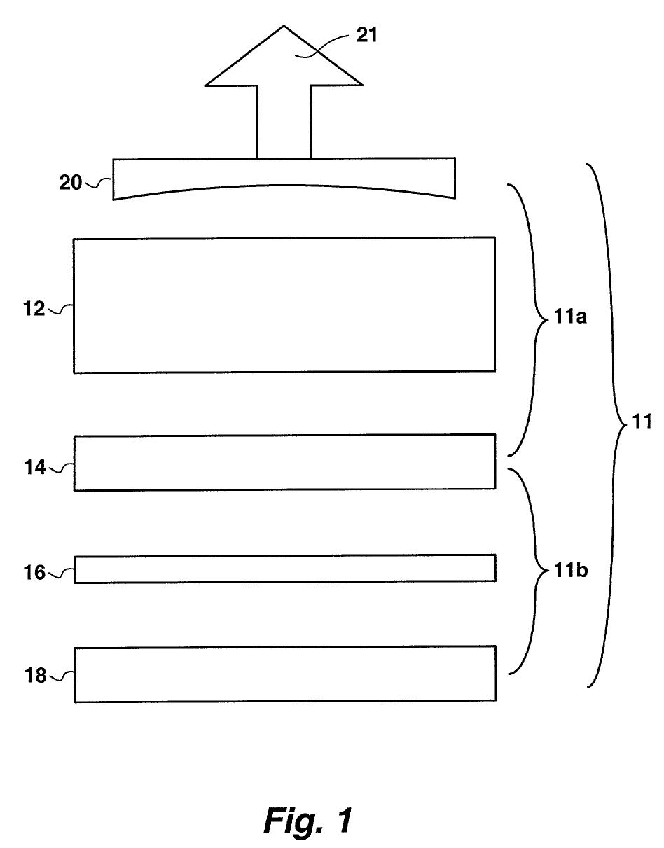

FIG. 1 shows a block diagram of a coupled cavity laser device of a type that may be modeled using the method of the present invention. The laser shown in FIG. 1 may be, for example, a semiconductor vertical cavity surface emitting laser (VCSEL), a semiconductor edge-emitting laser, solid state laser, or a gas laser. The laser shown in FIG. 1 employs a coupled cavity design, in which the resonance cavity 11 is comprised of an active sub-cavity 11b and a passive sub-cavity 11a. In this example, the active sub-cavity 11b extends between a bottom, fully-reflective mirror 18 and an intermediate, partially-reflective mirror 14. The active sub-cavity 11b is so-named because it contains an active gain medium 16 for generating light. The active gain medium 16 may be, for example, a quantum well structure comprised of alternating layers of semiconductor material. The invention, however is applicable to a laser with any type of gain medium including a solid state, gas, or quantum dot structure gain medium. The passive sub-cavity 11a extends between the partially-reflective mirror 14 and a partially-reflective output mirror 20. In this example, the output mirror 20 is shown as a curved mirror, which can be advantageous for improved transverse mode control since such a mirror operates as a lens to focus the reflected light. Various optical elements 12 may be included in the laser design which will impact the optical qualities of the resonance cavity 11. These elements are indicated as block 12, but are not restricted to any particular physical location within the scope of the invention. The optical elements 12 may include, for example, apertures, lenses, crystals, filters, or any other optical elements, in any combination. Any of the elements shown in the diagram may be misaligned by either translation or rotation so that the tolerance analysis predicting the performance of a real, misaligned system compared to the ideal, perfectly aligned system, can be performed.

The laser design illustrated in the example of FIG. 1 is referred to as a coupled-cavity design because the active and passive sub-cavities are coupled via the intermediate mirror 14. Light generated in the active gain region 16 is reflected between the bottom mirror 18 and the intermediate mirror 14. Since the intermediate mirror 14 is partially reflective, a portion of the generated light passes through the mirror 14, through optical elements 12 (e.g., an aperture) and out the output mirror 20. A portion of this light is reflected back toward the gain medium by the output mirror/lens 20, while a portion passes through the partially reflective mirror and forms the device output beam 21.

In the modeling method of the present invention, each of the mirrors in a laser resonance cavity is characterized by shape and wavelength-dependent reflectivity, transmissivity, and absorption with appropriate phase shifts. Each sub-cavity within the laser resonance cavity can include a number of optical elements, such as gain and/or absorption elements, dielectric media (including anisotropic media), lenses (including those with aberrations), optical apertures, random phase screens, gradient-index lenses, multi-layered isotropic or anisotropic materials, or other optical elements. These elements may be aligned to the center of the laser cavity, or may be misaligned.

The optical field in each sub-cavity is propagated using any of the known beam propagation modeling methods such as the ABCD beam propagation techniques described by Siegman, or Fourier-transformation-based propagation algorithms provided by GLAD software.

The present invention employs the argument outlined in Eqs. (1)-(4), stating that the arbitrary, multi-transverse-mode field will evolve into the lowest-loss spatial eigenmode after sufficiently large number of round-trips is performed. The method of the present invention for modeling multiple round trips in a coupled-cavity laser is as follows. One first chooses a reference surface in each sub-cavity of the laser where a field will be calculated as round-trips inside the laser are performed.

As used herein, the term “reference surface” means a particular area of a laser cavity in which a field may be calculated. A reference surface may correspond to a physical surface of the laser, but more commonly, it will be a conceptual slice through an internal portion of the laser cavity. In the examples described herein, the reference surfaces are planar slices internal to the laser cavity, and taken perpendicular to the direction of laser beam propagation. A reference surface may be, however, planar, spherical, or of any other shape, and may be oriented in any manner with respect to the direction of laser beam propagation, within the scope of the invention. The round-trip iteration inside the laser is defined by the round-trips in each sub-cavity and the boundary conditions at the intermediate mirror or mirrors defining the field exchange between coupled sub-cavities. In a two-cavity laser, a round-trip is modeled using the following set of equations (Eq. (5)).

$$\{ \begin{matrix}\hat{C} {E}_{1} = {\hat{R}}_{12} {\hat{C}}_{1} {E}_{1} + {\hat{T}}_{21} {\hat{C}}_{2} {E}_{2} \\ \hat{C} {E}_{12} = {\hat{T}}_{12} {\hat{C}}_{1} {E}_{1} + {\hat{R}}_{21} {\hat{C}}_{2} {E}_{2}\end{matrix} \qquad Eq . ( 5 )$$

The fields E₁ and E₂ in Eq. (5) are defined at the reference planes just below and just above the intermediate mirror 14 in FIG. 1, respectively, though the choice of other planes of reference inside each sub-cavity is allowed as well. The dependence of the fields E₁ and E₂ on the transverse coordinates is omitted in Eq. (5) for brevity but implied here and thereafter. The variables used in Eq. (5) above are defined in the table below.

| | |
|---|---|
| Ĉ = | circulation (round-trip propagation) operator for the laser |
| Ĉ₁ = | circulation operator for the first sub-cavity |
| Ĉ₂ = | circulation operator for the second sub-cavity |
| E₁ = | field in the first sub-cavity with the direction of propagation |
| | opposite to the direction of the output beam 21, taken at a plane |
| | of the intermediate mirror 14 perpendicular to the axis of the output |
| | beam 21, where the active cavity 11b couples to the passive |
| | cavity 11a |
| E₂ = | field in the second sub-cavity, with the direction of propagation |
| | aligned to the direction of the output beam 2, taken at a plane of |
| | the intermediate mirror 14 perpendicular to the axis of the output |
| | beam 21, where the active cavity 11b couples to the passive |
| | cavity 11a |
| \hat{R}₁₂ = | operator that represents a reflection of a complex field in the first |
| | sub-cavity from the mirror 18 dividing the first and the second |
| | sub-cavities |
| \hat{R}₂₁ = | operator that represents a reflection of a complex field in the |
| | second sub-cavity from the mirror 18 dividing the first and the |
| | second sub-cavities |
| \hat{T}₁₂ = | operator that represents a transmission of a complex field in the |
| | first sub-cavity through the mirror 18 into the second sub-cavity |
| \hat{T}₂₁ = | operator that represents a transmission of a complex field in the |
| | second sub-cavity through the mirror 18 into the first sub-cavity |

Equation (5) defines the circulation operator Ĉ for a two-cavity laser through circulation operators Ĉ₁ and Ĉ₂ for individual sub-cavities. The round-trip propagation in each sub-cavity, represented by operators Ĉ₁ and Ĉ₂ is carried out with the same beam propagation techniques as in the single-cavity Fox-Li-type simulation. The reflection and transmission, defining the coupling between two adjacent sub-cavities is modeled by the operators \hat{R}₁₂, \hat{R}₂₁, \hat{T}₁₂, and \hat{T}₂₁, which, in the simplest case are just complex numbers representing the wavelength-dependent amplitude reflection and transmission coefficients. These operators may be chosen to be dependent on x and y coordinates to model the effects of mirror curvature, non-uniformity, or misalignment.

Thus, the present invention asserts that the round-trip propagation in a coupled-cavity laser design can be modeled by separating it into parts which involve both (a) intra-cavity light propagations; and (b) and inter-cavity field exchange. For example, in a two sub-cavity laser, the fields are iterated as shown below:

$$\begin{matrix}( \begin{matrix}{E}_{1}^{new} \\ {E}_{2}^{new}\end{matrix} ) = \hat{C} ( \begin{matrix}{E}_{1}^{old} \\ {E}_{2}^{old}\end{matrix} ) \\ where & Eq . ( 6 ) \\ \hat{C} = ( \begin{matrix}{\hat{R}}_{12} {\hat{C}}_{1} \\ {\hat{T}}_{12} {\hat{C}}_{1}\end{matrix} \begin{matrix}{\hat{T}}_{21} {\hat{C}}_{2} \\ {\hat{R}}_{21} {\hat{C}}_{2}\end{matrix} ) & \end{matrix}$$

Ĉ is a two-by-two circulation matrix, whose diagonal elements represent intra-cavity circulation, and off-diagonal elements represent inter-cavity coupling.

For lasers with more than two sub-cavities, the size of the matrix increases. For example, if N is the number of sub-cavities in the laser, one has to select N reference surfaces, one for each sub-cavity, and use an N×N circulation matrix to perform the iterations.

A maximum gain (minimum loss) condition is satisfied by synchronizing a round-trip phase shift for each sub-cavity. For example, a computationally-intensive multi-wavelength simulation may be used. In such a simulation, each iteration is performed with respect to the same reference surface at which a complex field is a function of wavelength and of transverse coordinates on the reference surface. One or more values of the wavelength will receive maximum gain (minimum loss)—these are the wavelengths which correspond to the resonance of the entire coupled-cavity system. Thus, such a simulation will automatically select and enhance the lowest loss wavelengths. Alternatively, one can run a faster model at a single wavelength. In this type of simulation, a simple adjustment of the sub-cavity lengths or the wavelengths until the maximum gain is found will provide an approximate solution.

Modeling the laser under a condition of gain saturation is important for obtaining the correct spatial mode profile and the output power. A simple homogeneous-broadening gain model such as is used in known models (see, e.g., Siegman; L. A. Coldren and S. W. Corzine, “Diode Laser and Photonic Integrated Circuits,” Wiley, New York, 1995). Equation (7), below, gives the equation for the optical gain in a laser device, which can be used to model the gain and determine the saturation conditions

$$g = \frac{{g}_{0}}{1 + \frac{I}{{I}_{s}}} \qquad Eq . ( 7 )$$

Here g is the optical gain, g₀ is a small-signal gain, I is the total intensity of the optical field in the gain region, and I_{S} represents the saturation intensity. The quantities g, g₀, and I_{S} are, in general, functions of coordinates in the laser cavity and of the particular wavelength used in the calculation. Other models than the homogeneous broadening representation may also be used to model the gain of a laser device (see, e.g. the books by Siegman and by Coldren and Corzine).

The method of the present invention allows for complete two-dimensional, vector or scalar field description, with no paraxial approximation for beam propagation necessary. Assumption of spatial uniformity at each plane inside the cavity, frequently used in simplified models is not necessary. Insertion of non-uniform random phase and/or amplitude screen is just an additional step in the modeling of beam propagation in each sub-cavity or reflection from or transmission through a non-uniform mirror. No a priori assumption about the cavity modes (e.g. Gauss-Laguerre) must be made. The modes found are the exact modes of the active coupled-cavity laser system.

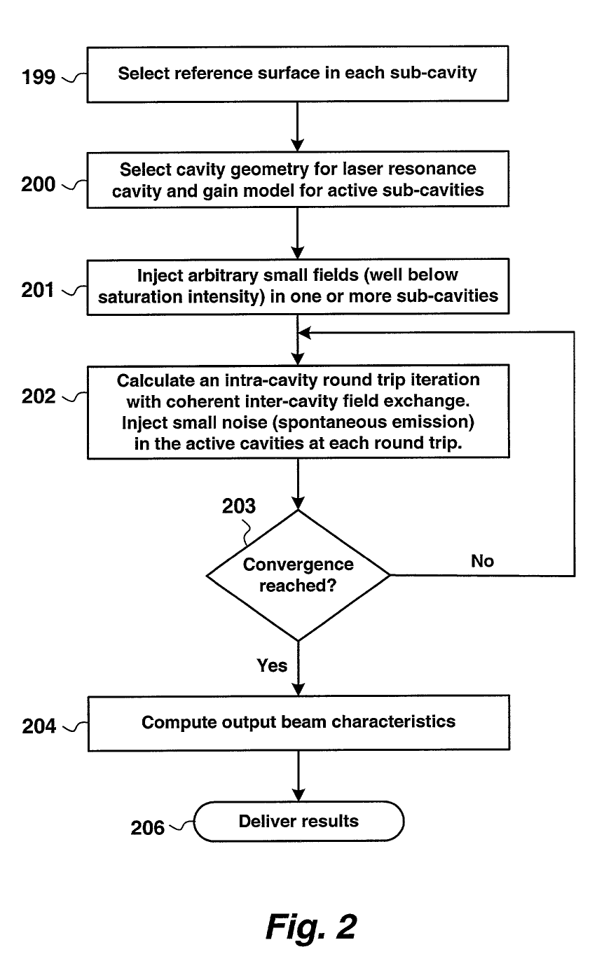

Referring now to FIG. 2, a flow chart showing a method according to an embodiment of the invention is shown. Reference surfaces are selected and field spatial distributions at each reference surface are calculated iteratively as multiple round-trips inside each sub-cavity are performed. Transmission and reflection of the fields at the partially reflective mirrors are included in the calculations. The present invention may be implemented, for example, in software such as C++, Fortran, GLAD, or any other appropriate software language. In this case, the software code may be converted into a set of instructions that are capable of being executed by a processor or the like. In step 199, reference surfaces are selected in each sub-cavity where the optical beam fields characterized by a certain direction of propagation are defined for further round-trip iterations. For example, in the example shown in FIG. 1, reference surfaces comprising planes may be selected at the upper and lower surfaces of partially-reflective mirror 14, so that one reference surface is located in the active sub-cavity 11b, and the other is located in the passive sub-cavity 11a.

In step 200, a laser resonance cavity geometry is selected. The resonance cavity geometry specifies various physical characteristics of the laser cavity including, for example, sub-cavity lengths; mirror reflectivities and curvatures; and sizes, locations, and characteristics of optical elements, such as an aperture. Also in step 200, a gain model which may be characterized by such characteristics as magnitude, wavelength dependence, and spatial coordinate dependence as in the model given by Eq. (7), is selected for the active sub-cavities of a laser device to be modeled. When the model of Eq. (7) is used, in many cases small-signal gain may be factored out into a product of an amplitude factor gₐ, a wavelength-dependent function g_{λ}(λ), and a coordinate-dependent function g_{c}(x, y, z). The dependence on the longitudinal coordinate z in g_{c}(x, y, z) is defined by a thickness of the active (gain) region.

In step 201, an arbitrary small field is injected into each sub-cavity. A good starting point is a plane wave or random noise, since each of them contains a fraction of dominant transverse modes of the laser cavity.

In step 202, a round trip iteration is calculated by applying Equation (6) to field data. According to Eq. (6), both intra-cavity round trip propagation and a coherent inter-cavity field exchange are performed in this calculation. In addition to the coherent inter-cavity field exchange factor, a noise factor may be injected into the intra-cavity round trip iteration calculation, for example, to represent spontaneous emission in an active cavity. The noise factor may be relatively small in relation to other factors in the calculation.

In step 203, an evaluation is performed to determine whether convergence has been reached. Convergence is reached when the fields (beams) in each sub-cavity stop changing their energies and transverse spatial distribution (shape). A convergence test may be performed by requiring that the energy of each beam change by no more than a certain small number (or percentage) on a round trip and/or that the correlation of each field with itself at the preceding iteration changes by no more than a certain small number (or percentage), generally different than the one used in the energy tests. Other criteria such as calculating change in the beam quality may be used. In some cases, it is desirable to investigate the modes of a passive coupled-cavity system (no active material, or gain). In this case, the step 200 is skipped and at the test step 203 only the convergence of the beam shape may be tested. If convergence has not been reached, step 202 is performed again and is once again tested for convergence. This loop is repeated until convergence is reached.

When step 203 indicates that convergence has been reached, output beam characteristics are calculated in step 204. The characteristics that may be calculated include, for example, output power, spatial profile (transverse mode), beam quality factor, wavelength, as well as other known beam characteristics. The output beam characteristics may be calculated by processing the complex field data resulting from step 203. The complex field data may be processed via known techniques (see, e.g., Siegman), which may be implemented in software such as C++ or FORTRAN, or the complex field data may be input to a software module such as provided in the GLAD software for processing to determine the output beam characteristics.

The results of the calculations performed in step 204 are output in step 206. Based on these results, a user may change certain design parameters or device characteristics in order to more accurately model a given design, or test a revised design to attempt to achieve selected desired results. Once the device parameters are altered, the method may be repeated to model a new device design, or to more accurately model a previously-used device design.

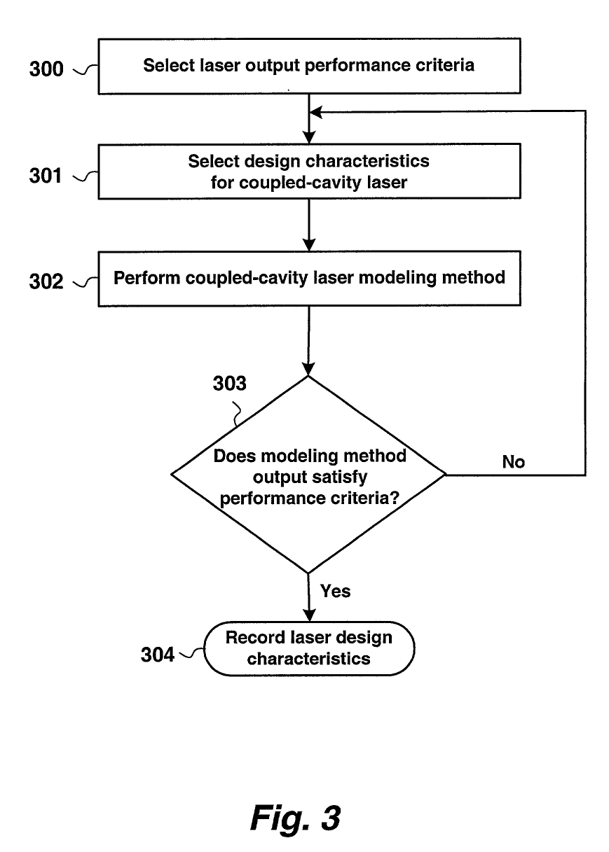

FIG. 3 shows a flow chart illustrating how a coupled cavity laser modeling method such as the one described in reference to FIG. 2 may be used to create an optimized laser design. In step 300, desired laser output performance criteria such as, for example, output power, spatial profile, misalignment sensitivity, beam quality factor, and wavelength are selected. In step 301, a coupled cavity laser design is proposed that will attempt to meet the performance criteria. This design may be comprised of various design characteristics such as, for example, resonant cavity length, number of sub-cavities, sub-cavity length, gain magnitude, number of mirrors, mirror reflectivities, materials, lenses, thermal characteristics, etc. and may be created as a modification of a previous design, or may be completely new.

In step 302, the design characteristics are input into a coupled cavity modeling method such as the one described in reference to FIG. 2. In step 303, the results calculated by the coupled cavity modeling method are compared to the desired laser output performance criteria selected in step 300. If the laser designed according to the design characteristics selected in step 301 meets the performance criteria, as indicated by the coupled cavity modeling method, the characteristics of the laser may be recorded as an approved design in step 304. If the laser does not meet the performance criteria, the design characteristics may be modified by returning to step 301 and selecting certain new characteristics and repeating step 302.

Although an embodiment of the invention is described as applied to a coupled cavity laser device having an active and a passive sub-cavity, the invention is equally applicable to modeling and design of laser devices having multiple sub-cavities, including devices having more than one gain region.

What is claimed is:

1. A method for modeling performance characteristics of a laser device wherein a resonance cavity of the laser device includes at least two sub-cavities, the method comprising:
selecting a reference surface in each sub-cavity;
selecting a gain model of at least one sub-cavity;
selecting a resonance cavity geometry;
injecting a small field in at least one sub-cavity;
performing an intra-cavity round trip iteration calculation, including inter-cavity field exchange, for each sub-cavity;
performing a convergence test to determine whether convergence has been reached;
if convergence has not been reached, performing an intra-cavity round trip iteration calculation for each sub-cavity;
if convergence has been reached, computing an output beam characteristic.

2. The method of claim 1, wherein the selected gain model includes a gain magnitude characteristic.

3. The method of claim 1, further comprising delivering the computed output beam characteristics.

4. The method of claim 1, wherein performing an intra-cavity round trip iteration calculation for each sub-cavity includes injecting a noise factor into an active sub-cavity.

5. The method of claim 1, wherein the laser device is a semiconductor vertical cavity surface emitting laser.

6. The method of claim 1, wherein the output beam characteristic includes at least one of an output power, a spatial profile, a beam quality factor, and a wavelength.

7. A method for designing a laser device wherein a resonance cavity of the laser device includes at least two sub-cavities, the method comprising:
selecting laser output performance criteria;
selecting a reference surface in each sub-cavity;
selecting a gain model of at least one sub-cavity;
selecting a resonance cavity geometry;
injecting a small field in at least one sub-cavity;
performing an intra-cavity round trip iteration calculation, including inter-cavity field exchange, for each sub-cavity;
performing a convergence test to determine whether convergence has been reached;
if convergence has not been reached, performing an intra-cavity round trip iteration calculation for each sub-cavity;
if convergence has been reached, computing output beam characteristics;
comparing the output beam characteristics to the laser output performance criteria;
if the output beam characteristics do not satisfy the laser output performance criteria, modifying at least one characteristic of the laser device;
if the output beam characteristics satisfy the laser output performance criteria, recording a design characteristic of the laser.

8. The method of claim 7, wherein the selected gain model includes a gain magnitude characteristic.

9. The method of claim 7, wherein the laser output performance criteria includes misalignment sensitivity criteria, further comprising the step of:
performing a misalignment sensitivity tolerance analysis.

10. A method for modeling performance characteristics of a laser device wherein a resonance cavity of the laser device includes at least two sub-cavities, the method comprising:
selecting a reference surface in at least one sub-cavity;
injecting a small field in at least one sub-cavity;
performing an intra-cavity round trip iteration calculation for at least one sub-cavity;
performing a convergence test to determine whether convergence has been reached;
if convergence has not been reached, performing an intra-cavity round trip iteration calculation for each sub-cavity;
if convergence has been reached, computing an output beam characteristic.

11. A set of instructions residing in a storage medium, said set of instructions capable of being executed by a processor to implement a method for modeling performance characteristics of a laser device wherein a resonance cavity of the laser device includes at least two sub-cavities, the method comprising:
selecting a reference surface in each sub-cavity;
selecting a gain model of at least one sub-cavity;
selecting a resonance cavity geometry;
performing an intra-cavity round trip iteration calculation after a small field is injected in at least one sub-cavity, said round trip iteration calculation including inter-cavity field exchange, for each sub-cavity;
performing a convergence test to determine whether convergence has been reached;
if convergence has not been reached, performing an intra-cavity round trip iteration calculation for each sub-cavity;
if convergence has been reached, computing an output beam characteristic.

12. The set of instructions of claim 11, wherein the selected gain model includes a gain magnitude characteristic.

13. The set of instructions of claim 11, wherein the method further comprises delivering the computed output beam characteristics.

14. The set of instructions of claim 11, wherein performing an intra-cavity round trip iteration calculation for each sub-cavity includes injecting a noise factor into an active sub-cavity.

15. The set of instructions of claim 11, wherein the laser device is a semiconductor vertical cavity surface emitting laser.

16. The set of instructions of claim 11, wherein the output beam characteristic includes at least one of an output power, a spatial profile, a beam quality factor, and a wavelength.

17. A set of instructions residing in a storage medium, said set of instructions capable of being executed by a processor to implement a method for designing a laser device wherein a resonance cavity of the laser device includes at least two sub-cavities, the method comprising:
selecting laser output performance criteria;
selecting a reference surface in each sub-cavity;
selecting a gain model of at least one sub-cavity;
selecting a resonance cavity geometry;
performing an intra-cavity round trip iteration calculation after a small field is injected in at least one sub-cavity, the intra-cavity round trip iteration calculation including inter-cavity field exchange, for each sub-cavity;
performing a convergence test to determine whether convergence has been reached;
if convergence has not been reached, performing an intra-cavity round trip iteration calculation for each sub-cavity;
if convergence has been reached, computing output beam characteristics;
comparing the output beam characteristics to the laser output performance criteria;
if the output beam characteristics do not satisfy the laser output performance criteria, modifying at least one characteristic of the laser device;
if the output beam characteristics satisfy the laser output performance criteria, recording a design characteristic of the laser.

18. The set of instructions of claim 17, wherein the selected gain model includes a gain magnitude characteristic.

19. The set of instructions of claim 17, wherein the laser output performance criteria includes misalignment sensitivity criteria, the method further comprising the step of:
performing a misalignment sensitivity tolerance analysis.

20. A set of instructions residing in a storage medium, said set of instructions capable of being executed by a processor to implement a method for modeling performance characteristics of a laser device wherein a resonance cavity of the laser device includes at least two sub-cavities, the method comprising:
selecting a reference surface in at least one sub-cavity;
performing an intra-cavity round trip iteration calculation for at least one sub-cavity after a small field is injected in said at least one sub-cavity;
performing a convergence test to determine whether convergence has been reached;
if convergence has not been reached, performing an intra-cavity round trip iteration calculation for each sub-cavity;
if convergence has been reached, computing an output beam characteristic.
